(19) United States
(12) Patent Application Publication
(10) Pub. No.: US 2023/0288083 A1
(43) Pub. Date: Sep. 14, 2023

(54) AIR CONDITIONER

(71) Applicant: LG ELECTRONICS INC., Seoul (KR)

(72) Inventors: Junghyeon KIM, Seoul (KR); Chanseung PARK, Seoul (KR); Suhyeon JEONG, Seoul (KR); Geunyoung PARK, Seoul (KR); Sooyeon SHIN, Seoul (KR)

(21) Appl. No.: 18/118,843

(22) Filed: Mar. 8, 2023

(30) Foreign Application Priority Data
Mar. 8, 2022 (KR) 10-2022-0029673
Oct. 25, 2022 (KR) 10-2022-0137908

(51) Int. Cl. F24F 8/192; B03C 3/36; B03C 3/82

(52) U.S. Cl. CPC F24F 8/192; B03C 3/368; B03C 3/82

(57) ABSTRACT

An air conditioner includes: a housing having an inlet on one side thereof and an outlet on another side thereof; a fan disposed in the housing and by which air flows from the inlet to the outlet; and an electrostatic dust collector disposed in the housing and configured to remove foreign matter from air introduced into the inlet, allowing the air introduced into the inlet to be filtered. The electrostatic dust collector includes: at least one electrostatic filter including a first side wall and a second side wall disposed in an opposite direction to the first side wall; a first filter handle coupled to the first side wall; and a second filter handle coupled to the second side wall.

### CROSS-REFERENCE TO RELATED APPLICATION(S)

This application claims priority under 35 U.S.C. § 119 to Korean Application No. 10-2022-0029673 filed on Mar. 8, 2022, and Korean Application No. 10-2022-0137908 filed on Oct. 25, 2022, whose entire disclosures are hereby incorporated by reference.

### BACKGROUND

### 1. Field

The present disclosure relates to an air conditioner, and more particularly, to an air conditioner installed in an indoor space.

### 2. Background

An air conditioner is a device that controls the temperature of an indoor space by discharging heat-exchanged air to the indoor space.

Such an air conditioner is provided in an indoor space to supply air by exchanging heat with air introduced from the outside or air circulated in the indoor space. The air conditioner provided in the indoor space may be installed on a floor surface, a wall surface, or a ceiling of the indoor space.

The size of the air conditioner may vary depending on the size of the indoor space. In addition, the size of an inlet and an outlet formed in the air conditioner may vary according to the size of the air conditioner.

A filter for removing foreign matter or pollutants from air sucked in may be provided in the air conditioner. A pre-filter, an electrostatic filter, or the like may be disposed at the inlet of the air conditioner.

The size of the electrostatic filter may vary depending on the size of the air conditioner. Electrostatic filters in different sizes may be manufactured separately, causing an increase in cost required for the manufacturing process.

Korean Laid-Open Patent Publication No. KR 10-2020-0111571, which is hereby incorporated by reference, discloses an electrostatic filter installed at a wall-mounted air conditioner. However, due to its standardized and fixed size, application of electrostatic filter is difficult when there is a change of an inlet in size.

### BRIEF DESCRIPTION OF THE DRAWINGS

The embodiments will be described in detail with reference to the following drawings in which like reference numerals refer to like elements wherein:

FIG. 1 is a bottom perspective view illustrating an example of an air conditioner.

FIG. 2 is a bottom view of FIG. 1.

FIG. 3 is a cross-sectional view taken along the line X-X′ of FIG. 2.

FIG. 4 is a bottom view illustrating an example of an electrostatic dust collector.

FIG. 5 is a perspective view illustrating an example of an electrostatic dust collector.

FIG. 6 is a perspective view illustrating an example of a disassembled state of an electrostatic dust collector.

FIG. 7 is a perspective view illustrating an example of an electrostatic filter seen from one side.

FIG. 8 is a perspective view illustrating an example of an electrostatic filter seen from another side.

FIG. 9 is an exploded perspective view illustrating an example of an electrostatic dust collector.

FIG. 10 is a front view illustrating an example of an electrostatic film.

FIG. 11 is an enlarged perspective view illustrating an example of a region of an exposed end portion of an electrostatic film.

FIG. 12 is a perspective view illustrating an example of a dissembled state between a contact bracket and a bracket holder.

FIG. 13 is a perspective view illustrating an example of a coupled state between a contact bracket and a bracket holder.

FIG. 14 is a planar view illustrating an example of a contact bracket and a bracket holder.

FIG. 15 is a side view illustrating an example of an electrostatic filter with a contact bracket and a bracket holder being removed.

FIG. 16 illustrates an example of a state in which a contact bracket and a bracket holder are inserted into a case.

FIG. 17 illustrates an example of a contact relationship between the contact bracket and a plurality of electrostatic films of FIG. 16.

FIG. 18 is a cross-sectional view illustrating an example of an electrostatic film with a contact bracket being mounted to a case.

FIG. 19 is a perspective view illustrating an example of a second filter handle.

FIG. 20 is a side view illustrating an example of a second filter handle.

FIG. 21 is a planar view illustrating an example of a second filter handle.

FIG. 22 is an exploded perspective view illustrating an example of a second filter handle.

FIG. 23 illustrates an example of a coupling relationship between an electrostatic filter and a filter handle.

FIG. 24 illustrates an example of a connection relationship between a contact bracket and a first connector with an electrostatic filter and a filter handle being coupled to each other.

FIG. 25 illustrates an example of a connection relationship between a contact bracket and a second connector with an electrostatic filter and a filter handle being coupled to each other.

FIG. 26 is a cross-sectional view illustrating an example of a state before a filter handle and a filter housing are coupled to each other.

FIG. 27 is a cross-sectional view illustrating an example of a coupled state between a filter handle and a filter housing.

FIG. 28 illustrates an example of a coupled state between one electrostatic filter and two filter handles.

FIG. 29 illustrates an example of a coupled state between three electrostatic filters and two filter handles.

FIG. 30 is an exploded view illustrating an example of an electrostatic dust collector.

FIG. 31 is a planar view illustrating an example of an electrostatic dust collector.

FIG. 32 is a cross-sectional view illustrating an example of an air conditioner.

### DETAILED DESCRIPTION

The above and other aspects, features and other advantages of the present disclosure will be more clearly understood from the following detailed description taken in conjunction with the accompanying drawings. Exemplary embodiments will now be described more fully hereinafter with reference to the accompanying drawings; however, they may be embodied in many different forms and should not be construed as limited to the embodiments set forth herein. Rather, these embodiments are provided so that this disclosure will be thorough and complete, and will fully convey the scope of the exemplary embodiments to those skilled in the art. The same reference numerals are used throughout the drawings to designate the same or similar components.

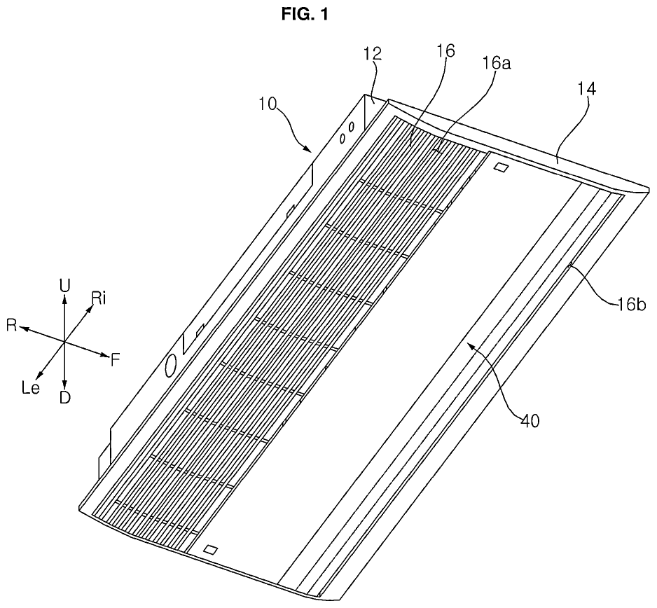

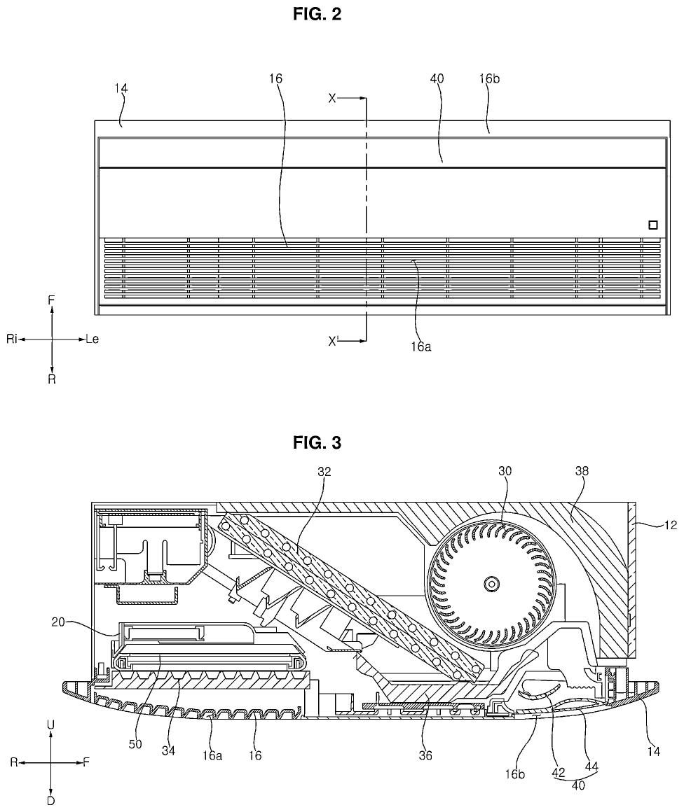

It will be understood that although the terms “first”, “second”, etc. may be used herein to describe various elements, these elements should not be limited by these terms. These terms are only used to distinguish one element from another. The directions up (U), down (D), left (Le), right (Ri), front (F), and rear (R) shown in FIGS. 1 to 3, and FIGS. 26 and 27 are for the convenience of description, and the present disclosure should not be limited by these directions. Thus, these directions may be described differently depending on the reference or origin.

Hereinafter, an air conditioner according to embodiments of the present disclosure will be described with reference to the accompanying drawings.

<Overall Configuration>

The air conditioner of the present disclosure is configured such that air sucked in is discharged through a pre-filter 34 and an electrostatic dust collector (or electrostatic precipitator) 50. Therefore, the air conditioner of the present disclosure may be an air conditioner that also functions as an air cleaner.

The air conditioner of the present disclosure may include a housing 10 having an inlet 16a and an outlet 16b, a heat exchanger 32 disposed in the housing 10, a fan 30 rotatably disposed in the housing 10, the pre-filter 34 disposed at the inlet 16a, the electrostatic dust collector 50 configured to remove foreign matter or pollutants from air that has passed through the pre-filter 34, and a vane module 40 configured to control a wind direction of air flowing to the outlet 16b.

The housing 10 includes an upper housing 12 defining a space therein and a lower housing 14 disposed under the upper housing 12 and having the inlet 16a and the outlet 16b. Referring to FIG. 3, the upper housing 12 is provided with an air guider 38 configured to guide air flowing to the outlet 16b through the fan 30.

The inlet 16a of the lower housing 14 is provided with an inlet panel 16. The pre-filter 34 and the electrostatic dust collector 50 are disposed above the inlet panel 16. A filter housing 20 to which the electrostatic dust collector 50 is mounted is disposed on an upper side of the lower housing 14.

The vane module 40 may include an outer vane 42 and an inner vane 44. The outer vane 42 and the inner vane 44 may operate in conjunction with each other. The outer vane 42 and the inner vane 44 may guide air discharged from the outlet 16b in a horizontal direction or a vertical direction. The vane module 40 may be provided with a vertical vane (not shown) to guide air discharged from the outlet 16b in a left-and-right direction. The housing 10 may be provided therein with a drain pan 36 to temporarily store condensed water (condensate) generated in the heat exchanger 32.

<Electrostatic Dust Collector>

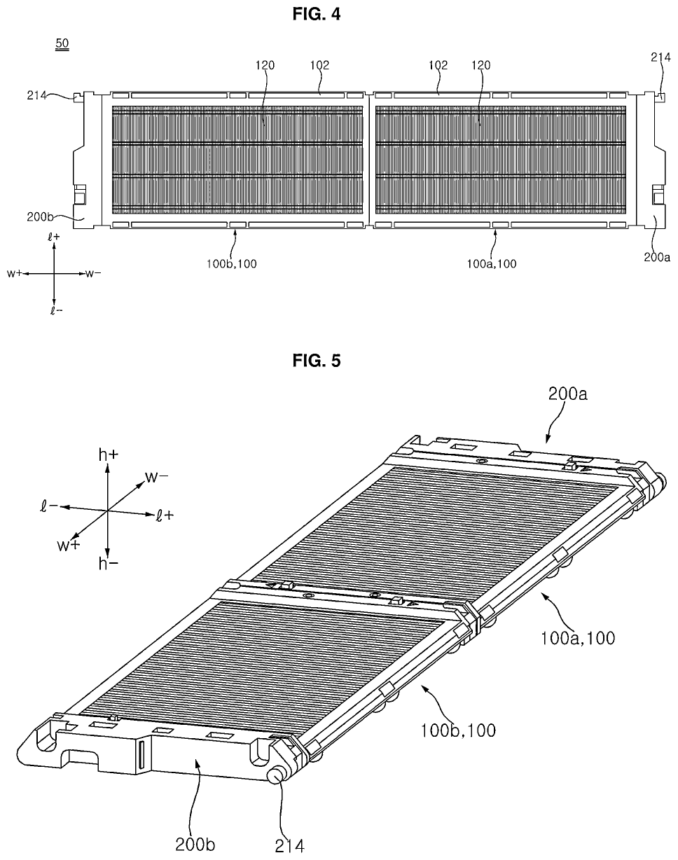

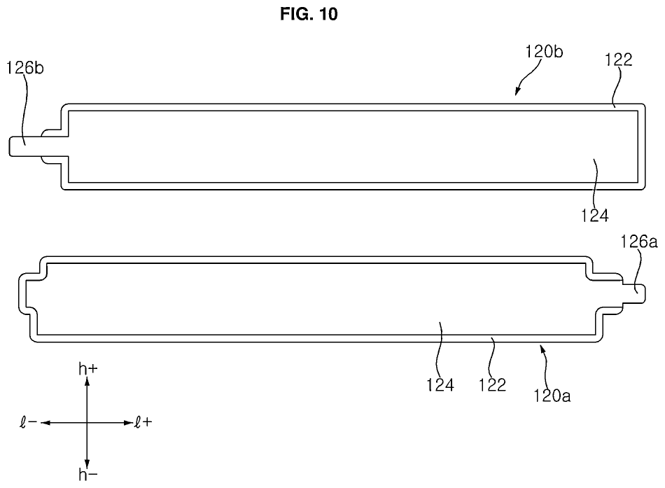

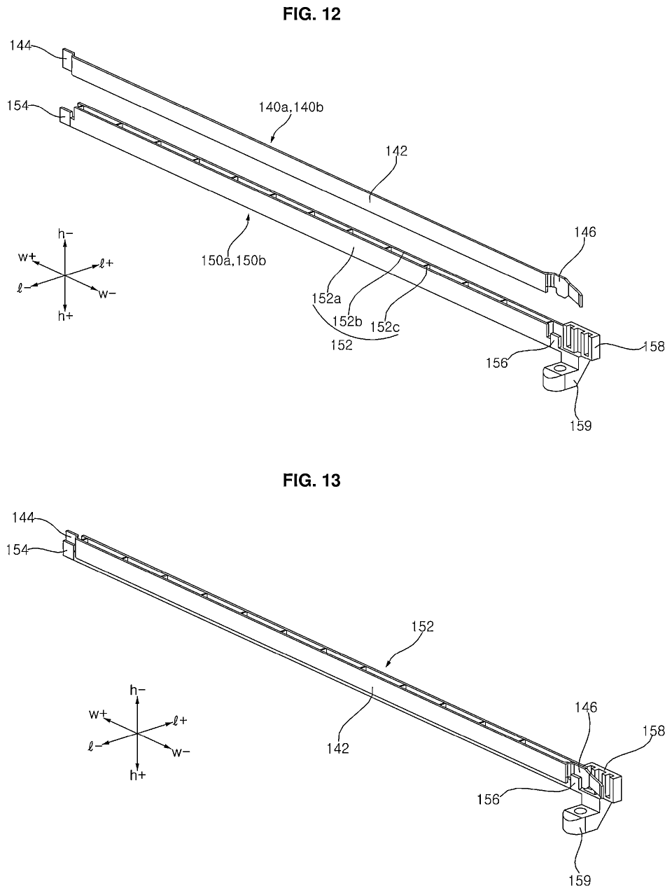

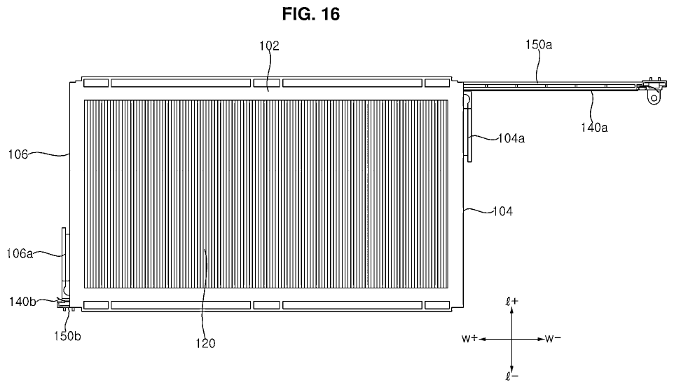

Hereinafter, the electrostatic dust collector 50 according to an embodiment of the present disclosure will be described with reference to FIGS. 4 to 29. In FIGS. 4 to 25, and FIGS. 28 and 29, description is given based on the length (or depth) direction (I+, I−), width direction (w+, w−), and height direction (h+, h−) of the electrostatic dust collector 50 (or the electrostatic filter 100).

The electrostatic dust collector 50 includes at least one electrostatic filter 100 that collects dust particles from air. The electrostatic filter 100 may have a first side wall 104 on one side thereof and a second side wall 106 disposed in an opposite direction to the first side wall 104. The first side wall 104 is provided with a first coupling protrusion 104a protruding therefrom. The second side wall 106 is provided with a second coupling recess 106b corresponding to the first coupling protrusion 104a.

The first side wall 104 is provided with a first coupling recess 104b recessed therein. The second side wall 106 is provided with a second coupling protrusion 106a having a size inserted into the first coupling recess 104b and protruding therefrom.

The first coupling protrusion 104a and the first coupling recess 104b are spaced apart from each other in a front-and-rear direction on the first side wall 104. The second coupling protrusion 106a and the second coupling recess 106b are spaced apart from each other in the front-and-rear direction on the second side wall 106. The first coupling protrusion 104a and the second coupling protrusion 106a are disposed in opposite directions with respect to the front-and-rear direction.

The first coupling protrusion 104a has a structure that is inserted into the second coupling recess 106b. The first coupling recess 104b has a structure into which the second coupling protrusion 106a is inserted.

The electrostatic filter 100 includes a button 160a, 160b to fix the electrostatic filter 100. The button 160a, 160b includes a first button protrusion 162 protruding upward from an upper surface of the electrostatic filter 100, a restoring plate 166 to restore the position of the first button protrusion 162, and a second button protrusion 164 disposed to protrude from the first coupling protrusion 104a or the second coupling protrusion 106a and configured to move together with the first button protrusion 162.

The electrostatic dust collector 50 may include at least one filter handle disposed on one side of the electrostatic filter 100 and by which the electrostatic filter 100 is fixed to the housing 10. The filter handle is connected to the electrostatic filter 100 and has a structure that is fixed to the housing 10.

In one embodiment, referring to FIGS. 4 to 7, the electrostatic dust collector 50 may include a first filter handle 200a disposed on one side of the electrostatic filter 100 and by which the electrostatic filter 100 is fixed to the housing 10, and a second filter handle 200b disposed on another (or opposite) side of the electrostatic filter 100 and by which the electrostatic filter 100 is fixed to the housing 10. The filter handle of other shapes or forms may also be used for fixing the placement or position of the electrostatic filter 100 to the housing 10. Alternatively, the electrostatic filter 100 may be directly mounted to the housing 10 without the filter handle.

The first side wall 104 of the electrostatic filter 100 has a structure that is coupled to the first filter handle 200a, and the second side wall 106 of the electrostatic filter 100 has a structure that is coupled to the second filter handle 200b. The first side wall 104 of the electrostatic filter 100 has a structure corresponding to the second side wall 106, allowing one electrostatic filter 100 to be disposed adjacent to another electrostatic filter 100. That is, a plurality of electrostatic filters 100a and 100b may be disposed between the first filter handle 200a and the second filter handle 200b.

Referring to FIGS. 4 to 6, a first electrostatic filter 100a and a second electrostatic filter 100b may be disposed between the first filter handle 200a and the second filter handle 200b. The first electrostatic filter 100a and the second electrostatic filter 100b may have the same shape and size. The first electrostatic filter 100a and the second electrostatic filter 100b may be configured to be coupled to each other between the first filter handle 200a and the second filter handle 200b.

The first side wall 104 of the electrostatic filter 100 may have the same structure as one side wall of the second filter handle 200b. The second side wall 106 of the electrostatic filter 100 may have the same structure as one side wall of the first filter handle 200a.

<Electrostatic Filter>

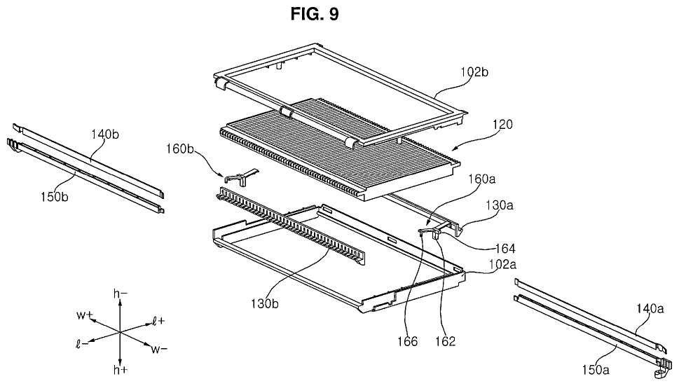

Referring to FIG. 9, the electrostatic filter 100 includes a case 102 that defines an outer appearance (or exterior) of the electrostatic filter 100 and is open to allow air to flow in the height direction of the electrostatic filter 100, a plurality of electrostatic films 120 that are spaced apart from each other in the case 102 and collect dust particles from air, and a film holder 130a, 130b that is disposed in the case 102 and by which the plurality of electrostatic films 120 are spaced apart from one another.

Referring to FIG. 9, the electrostatic filter 100 further includes the button 160a, 160b to maintain or release a coupled state of the electrostatic filter 100 with an adjacent electrostatic filter 100, the first filter handle 200a, or the second filter handle 200b. Referring to FIG. 9, the button 160a, 160b protrudes upward from the case 102. Referring to FIG. 9, the electrostatic filter 100 includes a first button 160a disposed on one side of the case 102 and a second button 160b disposed on another side of the case 102.

Each of the first button 160a and the second button 160b includes a first button protrusion 162 protruding toward an upper wall of the case 102, a restoring plate 166 to restore the position of the first button protrusion 162, and a second button protrusion 164 configured to move together with the first button protrusion 162. The position of the second button protrusion 164 also changes when the first button protrusion 162 is moved in an up-and-down direction. The restoring plate 166 may be disposed inside the case 102 to restore the position of the first button protrusion 162. Therefore, when no external force is applied, the position of the first button protrusion 162 may remain unchanged. When no external force is applied to the first button protrusion 162, the first button protrusion 162 may be disposed to protrude upward from an upper surface of the case 102. The second button protrusion 164 is disposed on the coupling protrusion 104a, 106a of the case 102 to be described hereinafter. When the coupling protrusion 104a, 106a is inserted into the coupling recess 104b, 106b, the second button protrusion 164 may be inserted into a fixing recess 104c, 106c formed on the coupling recess 104b, 106b. That is, the second button protrusion 164 may allow a coupled state between the electrostatic filter 100 and another electrostatic filter 100 to be maintained. In addition, the second button protrusion 164 may allow a coupled state between the electrostatic filter 100 and the first filter handle 200a or the second filter handle 200b to be maintained.

Referring to FIG. 9, the electrostatic filter 100 may include a contact bracket 140 that connects a plurality of electrodes spaced apart from one another and a bracket holder 150 that supports the contact bracket 140.

The case 102 has a flow hole through which air flows. The case 102 defines therein a space in which the plurality of electrostatic films 120 are disposed. The film holder 130a, 130b may allow the plurality of electrostatic films 120 to be spaced apart from each other at regular intervals in the case 102. A length of a first exposed end portion 126a or a second exposed end portion 126b protruding from the film holder 130a, 130b is greater than a distance between the film holder 130a, 130b and the contact bracket 140a, 140b. Referring to FIG. 15, when the case 102 is seen from the side, the case 102 may have a trapezoidal shape in which a length in the front-and-rear direction becomes narrower toward the top.

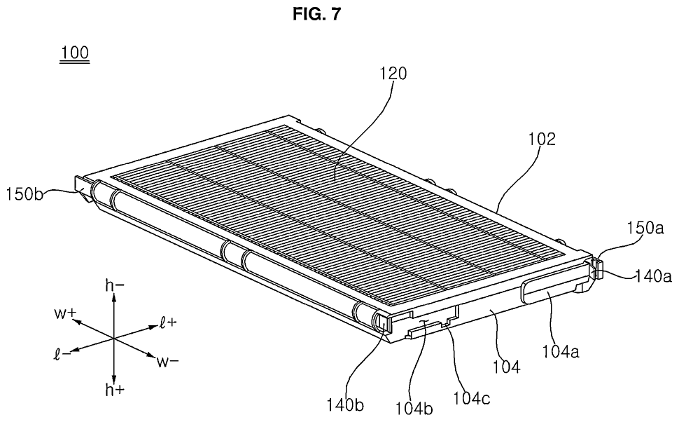

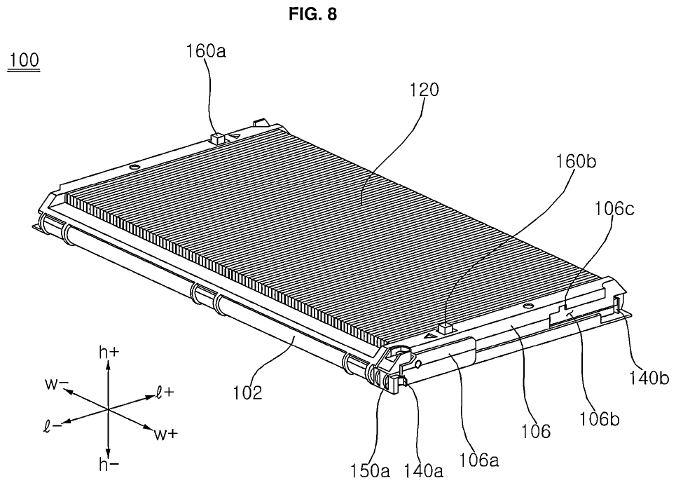

Referring to FIGS. 7 and 8, the case 102 includes the first side wall 104 to which the first filter handle 200a is mounted, and the second side wall 106 to which the second filter handle 200b is mounted. Another electrostatic filter 100 may be mounted to the first side wall 104 or the second side wall 106 of the case 102.

Referring to FIGS. 7 and 8, the first side wall 104 is disposed on the left of the case 102, and the second side wall 106 is disposed on the right of the case 102. The first side wall 104 and the second side wall 106 are disposed in opposite directions to each other.

The first side wall 104 is provided with the first coupling protrusion 104a protruding outward and the first coupling recess 104b recessed inward. The second side wall 106 is provided with the second coupling recess 106b recessed inward and the second coupling protrusion 106a protruding outward.

The first coupling protrusion 104a is disposed at the rear of the first side wall 104, and the first coupling recess 104b is disposed at the front of the first side wall 104. The second coupling recess 106b is disposed at the rear of the second side wall 106, and the second coupling protrusion 106a is disposed at the front of the second side wall 106.

The first filter handle 200a or a second side wall 106 of another electrostatic filter 100 may be connected to the first side wall 104. The second filter handle 200b or a first side wall 104 of another electrostatic filter 100b may be connected to the second side wall 106. Here, the term “being connected” may include an electrical connection between the plurality of electrostatic filters 100 in addition to a structural connection between the plurality of electrostatic filters 100.

The electrostatic filter 100 and the first filter handle 200a or the second filter handle 200b may move in the front-and-rear direction, and may be coupled or released in a sliding manner. The electrostatic filter 100 and another electrostatic filter 100 may move in the front-and-rear direction, and may be coupled or released in a sliding manner.

Unlike shown in the drawings, the electrostatic filter 100 and the first filter handle 200a or the second filter handle 200b may be coupled to or released (separated) from each other by using a method other than the sliding manner. That is, the electrostatic filter 100 and the first filter handle 200a or the second filter handle 200b may be fitted to each other in the up-and-down direction or the left-and-right direction.

Similarly, the electrostatic filter 100 and another electrostatic filter 100 may be coupled to or released (separated) from each other by using a method other than the sliding manner. The first coupling protrusion 104a has a shape corresponding to the second coupling recess 106b. The second coupling protrusion 106a has a shape corresponding to the first coupling recess 104b. Accordingly, the plurality of electrostatic filters 100 coupled to each other may be disposed in the left-and-right direction.

The first coupling protrusion 104a protrudes from the first side wall 104 in a ‘T’ shape. The second coupling recess 106b is recessed into the second side wall 106 in a ‘T’ shape. The second coupling protrusion 106a protrudes from the second side wall 106 in a ‘T’ shape. The first coupling recess 104b is recessed into the first side wall 104 in a ‘T’ shape.

Referring to FIGS. 7 and 8, the first coupling protrusion 104a and the second coupling protrusion 106a extend in the front-and-rear direction. The first coupling recess 104b and the second coupling recess 106b extend in the front-and-rear direction. Accordingly, the electrostatic filter 100 may be slidingly coupled to another electrostatic filter 100. The electrostatic filter 100 may be slidingly coupled to the first filter handle 200a or the second filter handle 200b.

A first fixing recess 104c may be formed on one side of the first coupling recess 104b in the up-and-down direction. A second fixing recess 106c may be formed on one side of the second coupling recess 106b in the up-and-down direction.

Part of a second button 160b disposed at a second coupling protrusion 106a of another electrostatic filter 100 may be inserted into the first coupling recess 104b. When a user presses the second button 160b, the part of the second button 160b is pulled out from the first coupling recess 104b, allowing the electrostatic filter 100 to slidingly move in the front-and-rear direction.

Part of a first button 160a disposed at a first coupling protrusion 104a of another electrostatic filter 100 may be inserted into the second coupling recess 106b. When the user presses the first button 160a, the part of the first button 160a is pulled out from the second coupling recess 106b, allowing the electrostatic filter 100 to slidingly move in the front-and-rear direction.

The case 102 is provided with an inlet hole 108a, 110a into which the contact bracket 140 and the bracket holder 150 are inserted. The contact bracket 140 and the bracket holder 150 may be inserted through the inlet hole 108a, 110a.

A first inlet hole 108a is formed in the first side wall 104 of the case 102. The first inlet hole 108a is disposed forward relative to the first coupling protrusion 104a. A second inlet hole 110a is formed in the second side wall 106 of the case 102. The second inlet hole 110a is disposed rearward relative to the second coupling protrusion 106a. The contact bracket 140 and the bracket holder 150 are mounted to the case 102 through the first inlet hole 108a or the second inlet hole 110a.

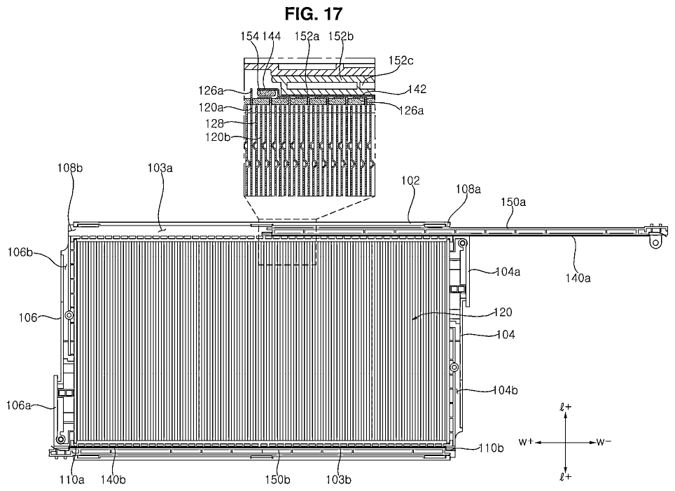

The second side wall 106 of the case 102 is provided with a first outlet hole 108b through which one end portion of the contact bracket 140 inserted into and mounted to the first inlet hole 108a is exposed. The first side wall 104 of the case 102 is provided with a second outlet hole 110b through which one end portion of the contact bracket 140 inserted into and mounted to the second inlet hole 110a is exposed. Referring to FIG. 17, the first inlet hole 108a is formed on one side of the first coupling protrusion 104a, and the first outlet hole 108b is formed on one side of the first coupling recess 104b.

The case 102 has a first contact space 103a in which the contact bracket 140 inserted through the first inlet hole 108a is disposed, and a second contact space 103b in which the contact bracket 140 inserted through the second inlet hole 110a is disposed. The first contact space 103a and the second contact space 103b are disposed in different directions. Referring to FIG. 17, the first contact space 103a is disposed forward relative to the plurality of electrostatic films 120, and the second contact space 103b is disposed rearward relative to the plurality of electrostatic films 120.

A first exposed end portion 126a of each of a plurality of first electrostatic films 120a to be described later may be disposed in the first contact space 103a. A second exposed end portion 126b of each of a plurality of second electrostatic films 120b to be described later may be disposed in the second contact space 103b.

Referring to FIG. 9, the case 102 may include an upper case 102a and a lower case 102b. The upper case 102a and the lower case 102b may be coupled to each other to define a space in which the plurality of electrostatic films 120 are disposed. In a state where the upper case 102a and the lower case 102b are coupled to each other, a coupling protrusion and a coupling recess are formed on both side walls of the case 102.

The plurality of electrostatic films 120 may be disposed in the case 102. Each of the plurality of electrostatic films 120 includes an electrode 124 formed of a conductive layer through which electricity flows, and a film 122 formed of an insulating layer to fix the position of the electrode 124. The case 102 may be provided therein with a spacer 128 disposed between each of the plurality of electrostatic films 120 and by which a separation distance between each of the plurality of electrostatic films 120 is maintained.

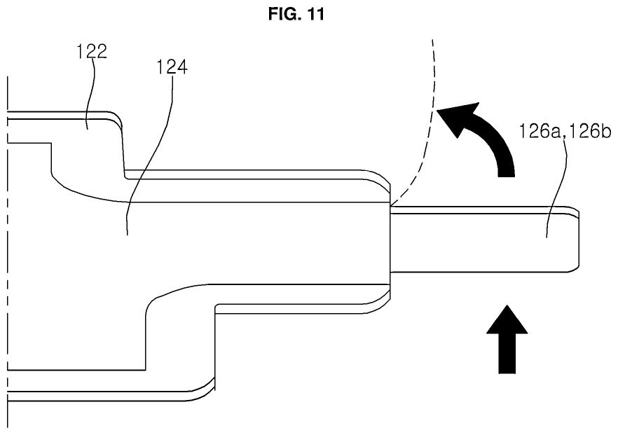

Referring to FIG. 11, the electrode 124 may be disposed inside the film 122. The electrode 124 may be surrounded by the film 122, so that a region in which electricity flows is not exposed to the outside. Referring to FIG. 11, the electrode 124 may include an exposed end portion 126, which is any one of the end portions in the front-and-rear direction, exposed from the film 122. The exposed end portion 126 may have an ultra-thin thickness to be deformed in the left-and-right direction. The exposed end portion 126 has a predetermined thickness or less to be deformable in a direction in which the contact bracket 140a, 140b is inserted.

The plurality of electrostatic films 120 may include a first electrostatic film 120a connected to a high voltage generating part (not shown) and a second electrostatic film 120b connected to a ground part (not shown). A plurality of first electrostatic films 120a and a plurality of second electrostatic films 120b may be alternately disposed with each other. The first electrostatic film 120a and the second electrostatic film 120b may have the same shape.

The first electrostatic film 120a and the second electrostatic film 120b are disposed such that the respective exposed end portions thereof are located in different directions. That is, referring to FIG. 17, the first exposed end portion 126a of the first electrostatic film 120a is disposed in the first contact space 103a. The second exposed end portion 126b of the second electrostatic film 120b is disposed in the second contact space 103b.

The electrostatic filter 100 includes a pair of contact brackets 140 and a pair of bracket holders 150. The electrostatic filter 100 includes a first contact bracket 140a and a first bracket holder 150a disposed in the first contact space 103a. The electrostatic filter 100 includes a second contact bracket 140b and a second bracket holder 150b disposed in the second contact space 103b.

The first contact bracket 140a and the second contact bracket 140b may have the same shape. The first bracket holder 150a and the second bracket holder 150b may have the same shape. In the following, the configuration of the contact bracket 140 and the bracket holder 150 will be described with reference to FIGS. 13 to 15. The structure of the contact bracket 140 described herein may be equally applied to the first contact bracket 140a and the second contact bracket 140b. In addition, the bracket holder 150 described herein may be equally applied to the first bracket holder 150a and the second bracket holder 150b.

The contact bracket 140 may include a contact body 142 in contact with the plurality of first electrostatic films 120 or the plurality of second electrostatic films 120, a first contact end portion 144 disposed on one side of the contact body 142 and exposed through the first outlet hole 108b or the second outlet hole 110b, and a second contact end portion 146 disposed on another (or opposite) side of the contact body 142 and exposed through the first inlet hole 108a or the second inlet hole 110a.

The contact body 142 has a structure that extends in the width direction (w+, w−) of the electrostatic filter 120 inside the case 102. The contact body 142 is disposed to intersect the plurality of electrostatic films 120 disposed in the case 102. The contact body 142 is disposed to be inclined with the plurality of electrostatic films 120. Referring to FIG. 17, the contact body 142 may be disposed perpendicular to the plurality of electrostatic films 120.

The contact body 142 is disposed on one side of a holder body 152 of the bracket holder 150 to be described hereinafter. In a state where the contact bracket 140 is mounted to the bracket holder 150, both ends of the contact bracket 140 are fixed to the bracket holder 150. The state in which the contact bracket 140 is mounted to the bracket holder 150 refers to a state in which the first contact end portion 144 is fixed to a first separation protrusion 154 of the bracket holder 150 and the second contact end portion 146 is fixed to a second separation protrusion 156 of the bracket holder 150 to allow the contact bracket 140 and the bracket holder 150 to move together. Accordingly, the contact bracket 140 and the bracket holder 150 may be inserted into the first inlet hole 108a or the second inlet hole 110a of the case 102 while the contact bracket 140 is being mounted to the bracket holder 150. The first contact end portion 144 and the second contact end portion 146 may extend in a direction away from the contact body 142 at a position spaced a predetermined distance apart from the contact body 142 in a direction in which the bracket holder 150 is disposed.

Referring to FIGS. 13 to 15, the first contact end portion 144 and the second contact end portion 146 may extend in the width direction (w+, w−) of the electrostatic filter 100 at a position spaced apart from the contact body 142 in an outward direction. Here, a direction in which the contact body 142 is disposed may be referred to as the inward direction, and a direction in which the holder body 152 of the bracket holder 150 is disposed may be referred to as the outward direction.

The first contact end portion 144 and the second contact end portion 146 extend in different directions with respect to the contact body 142. The first contact end portion 144 is bent from the contact body 142 in the outward direction and extends in an opposite direction to the contact body 142. The first contact end portion 144 extends in the opposite direction to the contact body 142 at a position spaced apart from the contact body 142 in the outward direction.

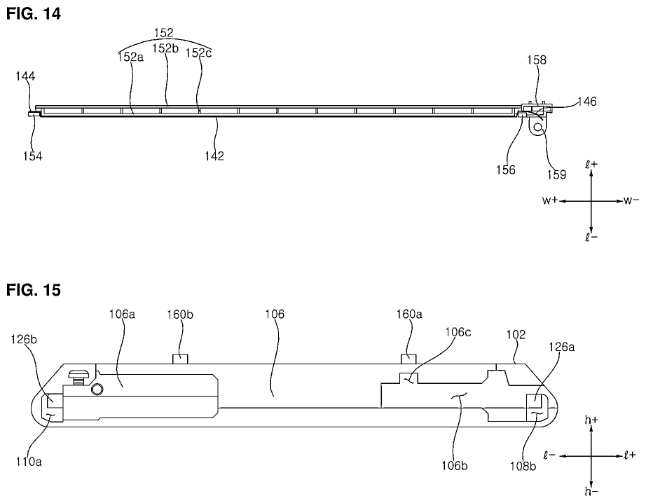

Referring to FIG. 14, the first separation protrusion 154 is disposed on one side of the contact body 142 in a direction in which the contact body 142 extends. Accordingly, the first contact end portion 144 connected to the contact body 142 may be bent along a perimeter of the first separation protrusion 154 to extend in the width direction (w+, w−) of the electrostatic filter 100. Due to the first separation protrusion 154 and the first contact end portion 144, movement of the contact bracket 140 in the width direction (w+, w−) of the electrostatic filter 100 or movement in the length direction (I+, I−) of the electrostatic dust collector 50 may be restricted.

The second contact end portion 146 is disposed on one side of the second separation protrusion 156. The second contact end portion 146 is bent from the contact body 142 in the outward direction and extends in an opposite direction to the contact body 142. The second contact end portion 146 extends in the opposite direction to the contact body 142 at a position spaced a predetermined distance apart from the contact body 142 in the outward direction. Referring to FIG. 14, the second separation protrusion 156 is disposed on another (or opposite) side of the contact body 142 in a direction in which the contact body 142 extends. Accordingly, the second contact end portion 146 connected to the another side of the contact body 142 may be bent along a perimeter of the second separation protrusion 156 to extend in the width direction (w+, w−) of the electrostatic filter 100. Due to the second separation protrusion 156 and the second contact end portion 146, movement of the contact bracket 140 in the width direction (w+, w−) of the electrostatic filter 100 or movement in the length direction (I+, I−) of the electrostatic dust collector 50 may be restricted.

A length of the second contact end portion 146 may be greater than a length of the first contact end portion 144. The first contact end portion 144 extends up to a portion where the first separation protrusion 154 of the bracket holder 150 to be described later is formed. The second contact end portion 146 extends longer than a portion where the second separation protrusion 156 is formed. The second contact end portion 146 may be bent in the inward direction at a region passing through the second separation protrusion 156.

In a state where the contact bracket 140 is mounted to the case 102, the contact body 142 is disposed to be in contact with the plurality of electrostatic films 120. Here, a state in which the contact bracket 140 is mounted to the case 102 refers to a state in which the first contact end portion 144 of the contact bracket 140 is disposed through the first outlet hole 108b or the second outlet hole 110b, and the contact bracket 140 is fixed to the case 102.

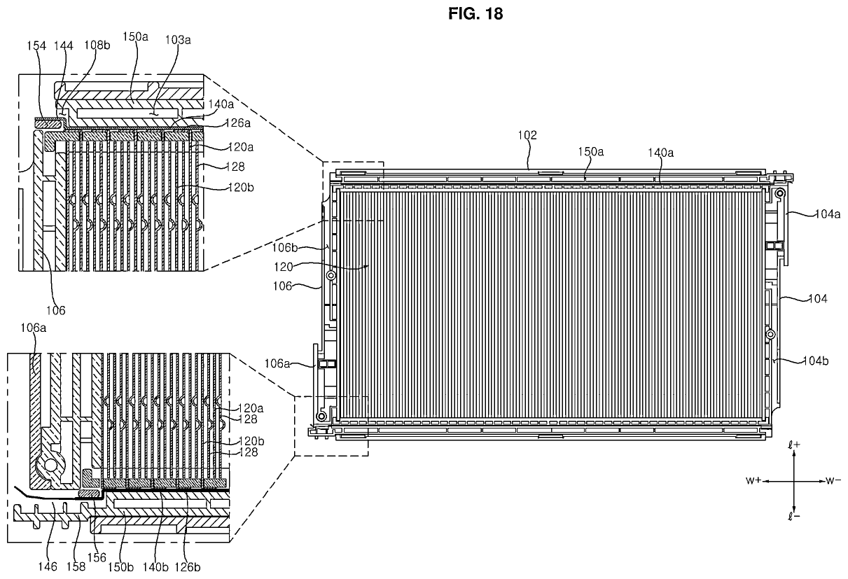

Referring to FIG. 18, in a state where the contact bracket 140 is mounted to the case 102, the first contact end portion 144 is disposed to be exposed to an outside of the case 102 through the first outlet hole 108b or the second outlet hole 110b. In addition, the second contact end portion 146 is disposed to be exposed to the outside of the case 102 through the first inlet hole 108a or the second inlet hole 110a.

The length of the second contact end portion 146 may be greater than the length of the first contact end portion 144. The second contact end portion 146 may have a structure that extends in the width direction (w+, w−) of the electrostatic filter 100 beyond the second separation protrusion 156.

The bracket holder 150 includes the holder body 152 disposed on one side of the contact body 142 of the contact bracket 140 to support the one side of the contact body 142, the first separation protrusion 154 disposed at one end portion of the holder body 152 to fix one end portion of the bracket 140, the second separation protrusion 156 disposed on another (or opposite) end portion of the holder body 152 to fix another (or opposite) end portion of the contact bracket 140, a holder grip 158 extending from the another end portion of the holder body 152, and a fastening portion 159 for fixing the bracket holder 150 to the case 102.

The holder body 152 may be disposed on one side of the contact body 142, and may support the shape or structure of the contact body 142. The contact body 142 may have a plate-shape with a thin thickness, allowing the contact body 142 to be easily deformed in shape. The holder body 152 is disposed in an outward direction of the contact body 142 to be in contact with the contact body 142. The holder body 152 may be in contact with a plurality of films 122 to prevent deformation of the shape of the contact body 142 inserted into the case 102.

Referring to FIG. 14, the holder body 152 includes a first body 152a extending in the width direction (w+, w−) of the electrostatic filter 100, a second body 152b disposed in parallel with the first body 152 at a position spaced apart from the first body 152a, and a connecting rib 152c provided between the first body 152a and the second body 152b to connect the first body 152a and the second body 152b. As the first body 152a and the second body 152b are connected by the connecting rib 152c, the rigidity of the holder body 152 may be reinforced.

Referring to FIG. 14, the first body 152a is disposed to be in contact with the contact body 142 at one side. The second body 152b may be spaced apart from the first body 152a in the outward direction. The holder body 152 may include a plurality of connecting ribs 152c. The plurality of connecting ribs 152c are spaced apart from each other in the width direction (w+, w−) of the electrostatic filter 100.

The first separation protrusion 154 is disposed on one side of the first body 152a. The first separation protrusion 154 is spaced apart from the first body 152a. The first contact end portion 144 that extends from the contact body 142 may be disposed between the first separation protrusion 154 and the first body 152a.

The second separation protrusion 156 is disposed on another (or opposite) side of the first body 152a. The second separation protrusion 156 is disposed opposite the first separation protrusion 154 with respect to the holder body 152. The second separation protrusion 156 is spaced apart from the first body 152a. The second contact end portion 146 that extends from the contact body 142 may be disposed between the second separation protrusion 156 and the first body 152a.

The holder grip 158 extends from the second body 152b in the width direction (w+, w−) of the electrostatic filter 100. The holder grip 158 may be spaced apart from the second separation protrusion 156 in the outward direction. The second contact end portion 146 may be disposed between the holder grip 158 and the second separation protrusion 156.

The holder grip 158 may protrude further in the outward direction than the second body 152b. Accordingly, when the contact bracket 140 and the bracket holder 150 are inserted into the case 102, the holder grip 158 is brought into contact with the case 102. Movement of the bracket holder 150 in an insertion direction into the case 102 may be restricted when the holder grip 158 comes into contact with one side of the case 102.

The fastening portion 159 may extend downward from the holder grip 158 to allow the bracket holder 150 to be fixed to one side of the case 102. The fastening portion 159 may fix the bracket holder 150 to the case 102 by using a separate fastening screw (not shown). In a state where the contact bracket 140 and the bracket holder 150 are mounted to the case 102, the bracket holder 150 may be fixed to the case 102 by the fastening screw. The state in which the contact bracket 140 and the bracket holder 150 are mounted to the case 102 may refer to a state in which the contact bracket 140 and the bracket holder 150 can no longer be inserted into the case 102. Referring to FIGS. 17 and 18, the case 102 may be provided therein with the first contact space 103a in which the first contact bracket 140a and the first bracket holder 150a are disposed, and the second contact space 103b in which the second contact bracket 140b and the second bracket holder 150b are disposed.

The first contact bracket 140a and the first bracket holder 150a may be inserted into the first inlet hole 108a formed in the case 102. The first contact bracket 140a and the first bracket holder 150a may be slidingly coupled to the case 102. When the first contact bracket 140a and the first bracket holder 150a are inserted into the case 102, the first contact bracket 140a and the first exposed end portion 126a of the first electrostatic film 120 may come into contact with each other. Referring to FIG. 11, the shape of the first exposed end portion 126a may be deformed by the first contact bracket 140a. Referring to FIG. 17, the shape of the first exposed end portion 126a may be deformed in a direction in which the first contact bracket 140a is inserted. In a state where the shape of the first exposed end portion 126a is deformed by the first contact bracket 140a, the first exposed end portion 126a is disposed to be in contact with the first contact bracket 140a. Likewise, the second contact bracket 140b and the second bracket holder 150b may come into contact with the second exposed end portion 126b of the second electrostatic film 120 disposed in the second contact space 103b.

Referring to FIG. 18, in a state where the first contact bracket 140a is mounted to the case 102, the first contact end portion 144 of the first contact bracket 140a is disposed to protrude from the first outlet hole 108b. The first contact end portion 144 of the first contact bracket 140a is disposed so as not to interfere with movement of the component inserted into the second coupling recess 106b while the first contact bracket 140a is being mounted to the case 102. Referring to FIG. 18, in a state where the first contact bracket 140a is mounted to the case 102, the first contact end portion 144 of the first contact bracket 140a is disposed so as not to protrude further than the second coupling recess 106b formed on the second side wall 106. Referring to FIG. 18, in a state where the first contact bracket 140a is mounted to the case 102, the first contact end portion 144 of the first contact bracket 140a is disposed so as not to protrude further in the width direction (w+, w−) of the electrostatic filter 100 than a wall surface defining the second coupling recess 106b.

Referring to FIG. 18, in a state where the first bracket holder 150a is mounted to the case 102, the first separation protrusion 154 of the first bracket holder 150a is disposed to protrude to an outside of the first outlet hole 108b. Referring to FIG. 18, in a state where the first bracket holder 150a is mounted to the case 102, the first separation protrusion 154 of the first bracket holder 150a is disposed so as not to protrude further in the width direction (w+, w−) of the electrostatic filter 100 than the wall surface defining the second coupling recess 106b.

Referring to FIG. 18, in a state where the first contact bracket 140a is mounted to the case 102, the second contact end portion 146 of the first contact bracket 140a is disposed to protrude to the outside of the case 102 from the first inlet hole 108a. Referring to FIG. 18, in a state where the first contact bracket 140a is mounted to the case 102, the second contact end portion 146 of the first contact bracket 140a is disposed so as to protrude further in the width direction (w+, w−) of the electrostatic filter 100 than the first coupling protrusion 104a formed on the first side wall 104.

Referring to FIG. 18, in a state where the first bracket holder 150a is mounted to the case 102, the second separation protrusion 156 of the first bracket holder 150a is disposed to protrude to an outside of the first inlet hole 108a. Referring to FIG. 18, in a state where the first bracket holder 150a is mounted to the case 102, the second separation protrusion 156 of the first bracket holder 150a is disposed so as not to protrude further in the width direction (w+, w−) of the electrostatic filter 100 than a wall surface defining the second coupling protrusion 106a. Referring to FIG. 18, the second contact bracket 140b and the second bracket holder 150b may be disposed in the same manner as the first contact bracket 140a and the first bracket holder 150a.

<First Filter Handle and Second Filter Handle>

Referring to FIGS. 4 to 6, the electrostatic dust collector 50 includes the first filter handle 200a and the second filter handle 200b. The first filter handle 200a and the second filter handle 200b may be left-right symmetric. The first filter handle 200a and the second filter handle 200b may have the same configuration. Part or some of the components included in each of the first filter handle 200a and the second filter handle 200b may be differently arranged.

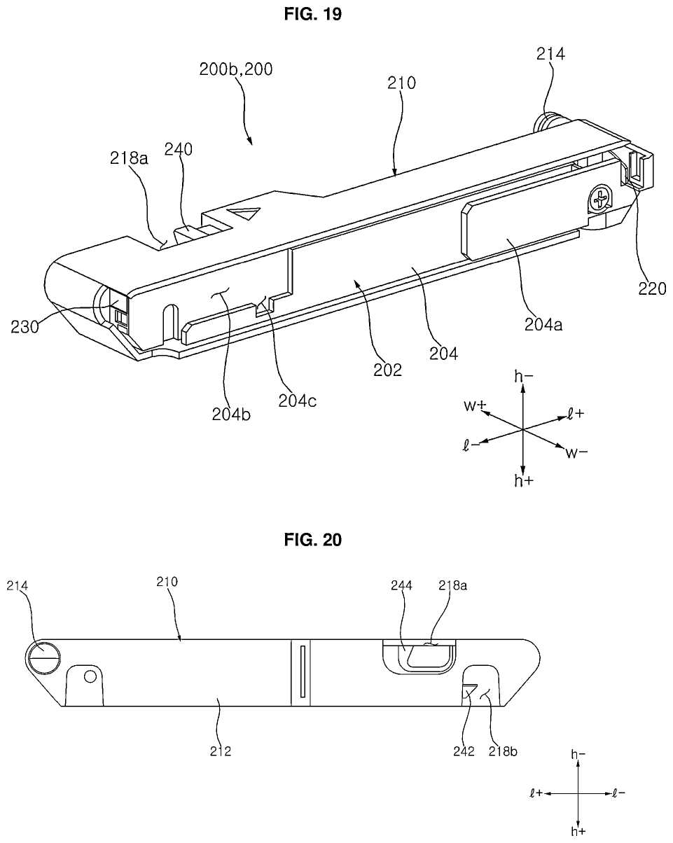

Hereinafter, the components of the second filter handle 200b will be described with reference to FIGS. 19 to 22. The second filter handle 200b includes an inner cover 202 that has a wall surface facing the electrostatic filter 100, an outer cover 210 that is disposed on one side of the inner cover 202 and is provided with a fixing protrusion 214 engaged with the housing 10, a handle button 240 to fix or release the second filter handle 200b to or from the housing 10, a first connector 220 that is disposed on one side of a corresponding protrusion 204a formed on one side of the inner cover 202 and is electrically connected to the electrostatic film 120, a second connector 230 that is disposed on one side of a corresponding recess 204b formed on another (or opposite) side of the inner cover 202, and a switch 250 that causes the first connector 220 and the second connector 230 to be short-circuited or un-short-circuited.

The inner cover 202 includes a corresponding wall 204 facing the electrostatic filter 100. The corresponding wall 204 of the inner cover 202 is provided with the corresponding protrusion 204a inserted into the coupling recess (104b, 106b) of the electrostatic filter 100, and the corresponding recess 204b into which the coupling protrusion (104a, 106a) of the electrostatic filter 100 is inserted. The inner cover 202 is provided with a first connector recess 206a defining a space in which the first connector 220 is accommodated, a second connector recess 206b defining a space in which the second connector 230 is accommodated, and a switch recess 206c defining a space in which the switch 250 is accommodated.

The outer cover 210 may be disposed to surround a remaining portion of the inner cover 202 except the corresponding wall 204. The outer cover 210 and the inner cover 202 may be coupled to each other. The outer cover 210 and the inner cover 202 may be coupled to each other by a separate fastening member.

The outer cover 210 may include an outer wall 212 that faces a surface opposite to the corresponding wall 204 of the inner cover 202. The outer wall 212 may be a wall surface that faces the filter housing 20 to which the filter handle 200a, 200b is mounted. The outer wall 212 may be provided with the fixing protrusion 214 to fix the filter handle 200a, 200b to the filter housing 20. The fixing protrusion 214 may be spaced apart from the handle button 240 in the length direction (I+, I−) of the electrostatic dust collector 50.

A first connector hole 216a through which part of the first connector 220 to be described later is exposed, a second connector hole 216b through which part of the second connector 230 to be described later is exposed, and a switch hole 216c through which part of the switch 250 is exposed may be formed on an upper surface of the outer cover 210.

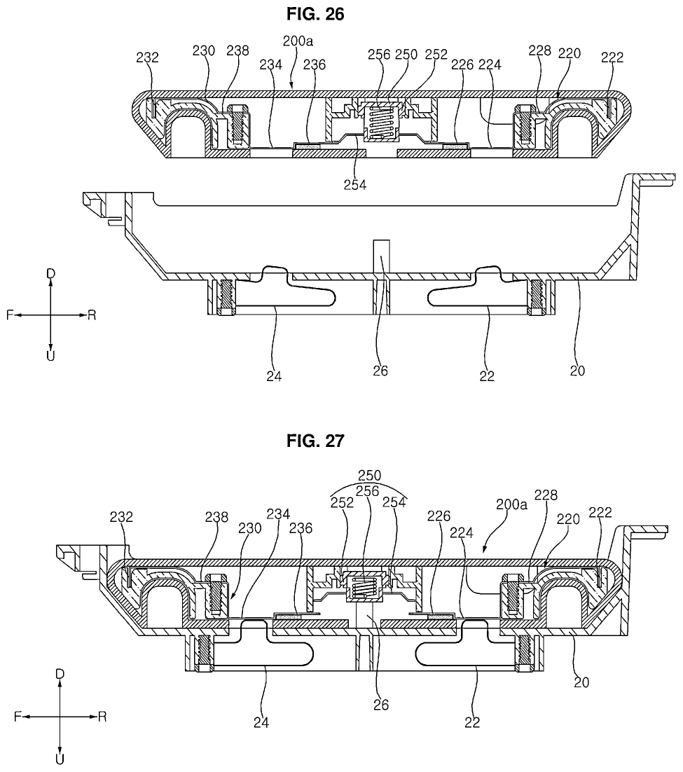

A first exposure plate 224 of the first connector 220 to be described later is disposed at the first connector hole 216a. A second exposure plate 234 of the second connector 230 to be described later is disposed at the second connector hole 216b. Referring to FIGS. 26 and 27, when the electrostatic dust collector 50 is mounted to the filter housing 20, the first connector 220 may come into contact with a first contact switch 22 provided at the filter housing 20. Referring to FIGS. 26 and 27, when the electrostatic dust collector 50 is mounted to the filter housing 20, the second connector 230 may come into contact with a second contact switch 24 provided at the filter housing 20.

Part of the switch 250 may be disposed in the switch hole 216c. Accordingly, when the electrostatic dust collector 50 is mounted to the filter housing 20, a shorting plate 254 of the switch 250 may be moved downward by a press protrusion 26 of the filter housing 20. As the shorting plate 254 is moved downward, contact between the shorting plate 254 and the first connector 220 and the second connector 230 may be released.

A first button hole 218a through which part of the handle button 240 is exposed may be formed on a lower surface of the outer cover 210, and a second button hole 218b through which another part of the handle button 240 is exposed may be formed on the upper surface of the outer cover 210. A press body 244 of the handle button 240 described hereinafter may be disposed in the first button hole 218a. A hook 242 of the handle button 240 to be described hereinafter may be disposed in the second button hole 218b.

The handle button 240 includes the hook 242 to fix the filter handle 200a, 200b to one side of the filter housing 20, the press body 244 configured to be changed in position by external pressure and configured to release the engagement of the hook 242, and an elastic body 246 configured to restore the position of the press body 244 when no external force is applied.

The press body 244 and the hook 242 may be formed as one body to move together. The press body 244 and the hook 242 may be configured to move in the length direction (I+, I−) of the electrostatic dust collector 50.

When no external force acts on the press body 244, the position of the press body 244 and the hook 242 may be determined by the elastic body 246. That is, as the elastic body 246 is disposed on one side of the outer cover 210, the position of the press body 244 and the hook 242 may be kept constant. When force is applied to the press body 244 by only the elastic body 246, the hook 242 may be engaged with one side of the filter housing 20. Accordingly, the electrostatic dust collector 50 may be fixed into the filter housing 20.

However, when the user or the like presses the press body 244, the position of the hook 242 may be changed. When pressure is applied to the press body 244 in an opposite direction to an elastic force of the elastic body 246, the engagement of the hook 242 may be released. Accordingly, one side of the electrostatic dust collector 50 fixed to the filter housing 20 may be released or separated from the filter housing 20.

The first connector 220 and the second connector 230 may allow the electrostatic filter 100 and the high voltage generating part or the ground part to be electrically connected to each other. The first connector 220 and the second connector 230 may be disposed opposite each other with respect to the switch 250. An end portion of each of the first connector 220 and the second connector 230 may be in contact with the shorting plate 254 of the switch 250.

The first connector 220 includes a first connecting plate 222 electrically connected to the electrostatic film 120 of the electrostatic filter 100, the first exposure plate 224 provided at the outer cover 210, the first contact plate 226 disposed to be in contact with the switch 250, and a first fastening plate 228 to fix the first connector 220 to one side of the inner cover 202.

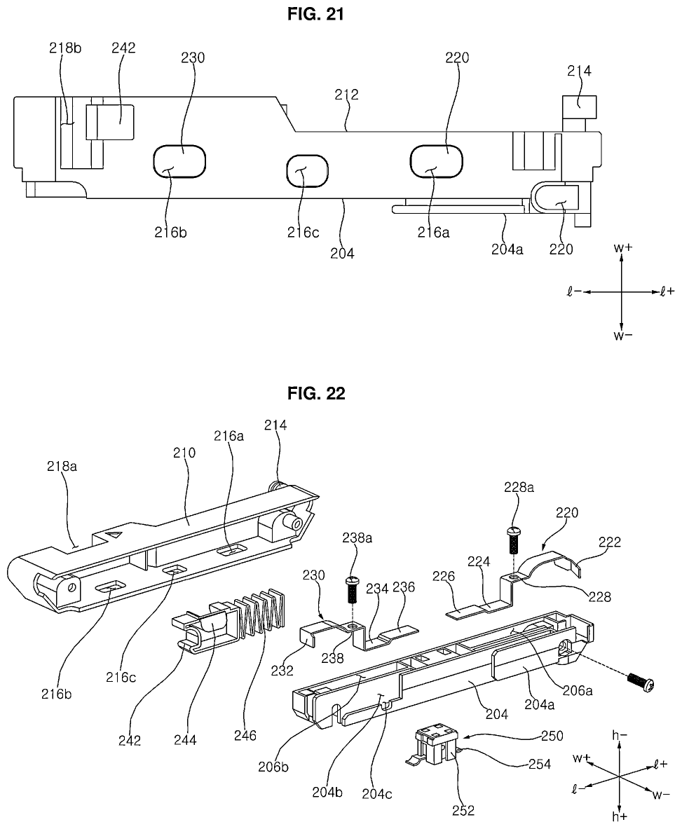

The first connecting plate 222 is disposed on one side of the corresponding protrusion 204a. Referring to FIG. 21, the first connecting plate 222 is disposed to protrude further than a side wall defining the corresponding protrusion 204a.

The first fastening plate 228 may be fixed to the inner cover 202 by using a separate fastening screw 228a. The second connector 230 includes a second connecting plate 232 electrically connected to the electrostatic film 120 of the electrostatic filter 100, the second exposure plate 234 disposed at the second connector hole 216b formed on the outer cover 210, a second contact plate 236 in contact with the switch 250, and a second fastening plate 238 to fix the second connector 230 to one side of the inner cover 202.

The second connecting plate 232 is disposed on one side of the corresponding recess 204b. The second connecting plate 232 is disposed so as not to protrude further than a side wall defining the corresponding recess 204b. The second fastening plate 238 may be fixed to the inner cover 202 by using a separate fastening screw 238a.

The switch 250 includes a switch body 252, the shorting plate 254 that connects the first connector 220 and the second connector 230, and an elastic body 256 disposed inside the switch body 252 and configured to the position of the shorting plate 254. The shorting plate 254 is configured to move in the height direction (h+, h−) of the electrostatic dust collector 50. The elastic body 256 applies a downward pressure to the shorting plate 254. Therefore, when no external force acts on the shorting plate 254, only an elastic force of the elastic body 256 acts to thereby fix the shorting plate 254 to a downward position.

When the shorting plate 254 is fixed to the downward position by the elastic body 256, the shorting plate 254 may come into contact with the first connector 220 and the second connector 230. When the position of the shorting plate 254 is moved upward by an external force, contact of the shorting plate 254 with the first connector 220 and the second connector 230 may be released.

The first filter handle 200a may include the same configuration as the second filter handle 200b. However, there may be some differences in the arrangement of the components of the first filter handle 200a and the components of the second filter handle 200b.

Referring to FIG. 19, the second filter handle 200b is configured such that the corresponding protrusion 204a is disposed at the front thereof and the corresponding recess 204b is disposed behind the corresponding protrusion 204a. In addition, the corresponding wall 204 facing the electrostatic filter 100 is disposed on a right side or surface of the second filter handle 200b. The second filter handle 200b is configured such that the first connector 220 provided on one side of the corresponding protrusion 204a is disposed at the front thereof, and the second connector 230 provided on one side of the corresponding recess 204b is disposed at the rear relative to the first connector 220.

The first filter handle 200a is configured such that the corresponding recess 204b is disposed at the front thereof, and the corresponding protrusion 204a is disposed behind the corresponding recess 204b. In addition, the corresponding wall 204 facing the electrostatic filter 100 is disposed on a left side or surface of the first filter handle 200a. The first filter handle 200a is configured such that the second connector 230 provided on one side of the corresponding recess 204b is disposed at the front thereof, and the first connector 220 provided on one side of the corresponding protrusion 204a is disposed at the rear relative to the second connector 230.

<Coupling Relationship>

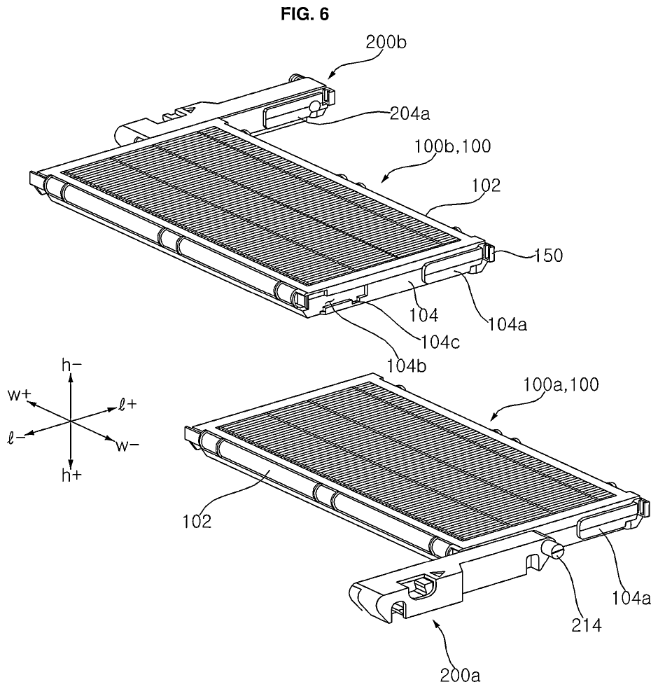

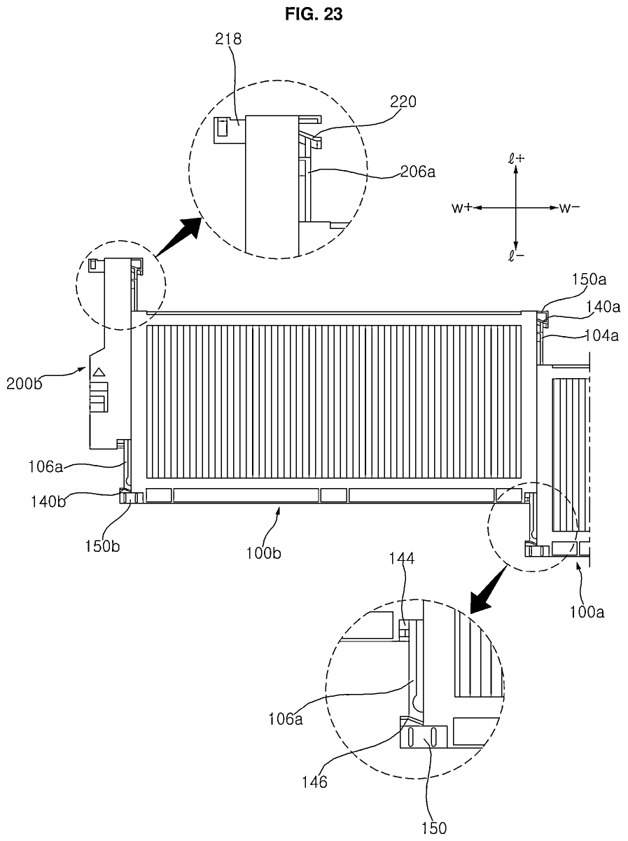

The electrostatic filter 100 may be connected to another electrostatic filter 100 or the filter handle 200a, 200b. The electrostatic filter 100 may be coupled to another electrostatic filter 100 or the filter handle 200a, 200b while moving forward and rearward. Referring to FIGS. 6 and 23, the electrostatic dust collector 50 according to an embodiment of the present disclosure may include the first electrostatic filter 100a and the second electrostatic filter 100b. A first coupling protrusion 104a and a first coupling recess 104b provided on a first side wall 104 of the second electrostatic filter 100b may be connected to a second coupling recess 106b and a second coupling protrusion 106a provided on a second side wall 106 of the first electrostatic filter 100a disposed adjacent to the second electrostatic filter 100b.

In addition, a first side wall 104 of the first electrostatic filter 100a may be connected to the first filter handle 200a disposed on one side of the first electrostatic filter 100a. Referring to FIG. 23, a second coupling protrusion 106a and a second coupling recess 106b disposed on a second side wall 106 of the second electrostatic filter 100b may be connected to the corresponding protrusion 204a and the corresponding recess 204b provided on the corresponding wall 204 of the second filter handle 200b.

The second coupling protrusion 106a and the second coupling recess 106b provided on the second side wall 106 of the first electrostatic filter 100a are respectively connected to the first coupling recess 104b and the first coupling protrusion 104a provided on the first side wall 104 of the second electrostatic filter 100b disposed adjacent to the first electrostatic filter 100a. In addition, the second side wall 106 of the second electrostatic filter 100b may be connected to the second filter handle 200b disposed on one side of the second electrostatic filter 100b. The second coupling protrusion 106a and the second coupling recess 106b provided on the second side wall 106 of the second electrostatic filter 100b may be connected to the corresponding protrusion 204a and the corresponding recess 204b of the second filter handle 200b.

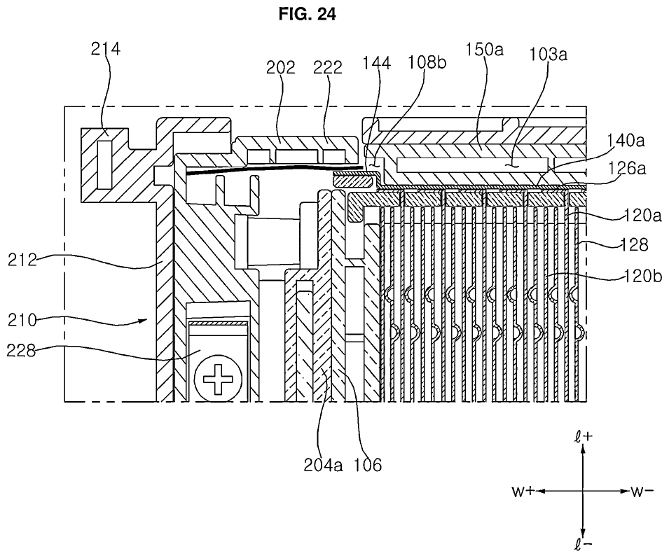

When the electrostatic filter 100a, 100b is connected to the filter handle 200a, 200b, the contact bracket 140 may be electrically connected to the first connector 220 of the filter handle 200a, 200b. Referring to FIG. 24, when the second electrostatic filter 100b is connected to the second filter handle 200b, the first contact end portion 144 of the first contact bracket 140a may come into contact with the first connecting plate 222 of the first connector 220 disposed on the second filter handle 200b. Although not shown in the drawings, the second contact end portion 146 of the first contact bracket 140a may come into contact with the second connecting plate 232 of the second connector 230 disposed on the first filter handle 200a.

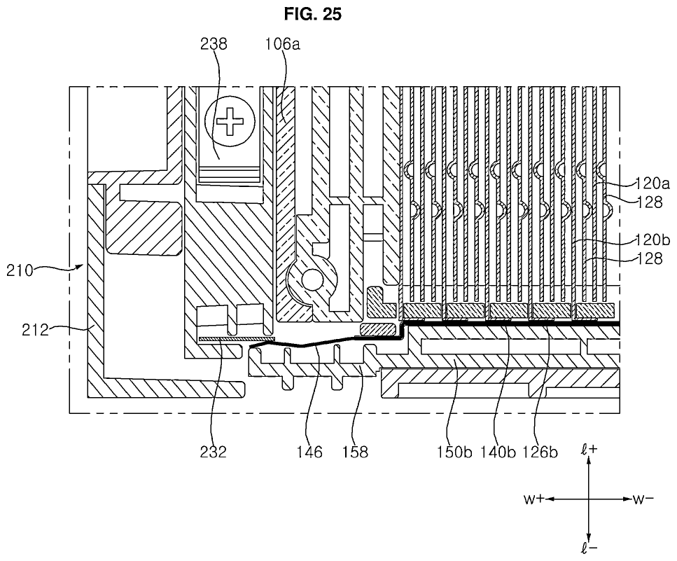

Also, referring to FIG. 25, when the second electrostatic filter 100b is connected to the second filter handle 200b, the second contact end portion 146 of the second contact bracket 140b may come into contact with the second connecting plate 232 of the second connector 230 disposed on the second filter handle 200b. Although not shown in the drawings, the first contact end portion 144 of the second contact bracket 140b may come into contact with the first connecting plate 222 of the first connector 220 disposed on the first filter handle 200a.

In addition, when one electrostatic filter 100 and another electrostatic filter 100 are connected to each other, a first contact end portion 144 of a first contact bracket 140a disposed on the one electrostatic filter 100 may come into contact with a second contact end portion 146 of a first contact bracket 140a disposed on the another electrostatic filter 100. That is, when the first electrostatic filter 100a and the second electrostatic filter 100b are connected to each other, the second contact end portion 146 of the second contact bracket 140b disposed on the first electrostatic filter 100a may come into contact with the first contact end portion 144 of the second contact bracket 140b disposed on the second electrostatic filter 100b. In addition, when the first electrostatic filter 100a and the second electrostatic filter 100b are connected to each other, the first contact end portion 144 of the first contact bracket 140a disposed on the first electrostatic filter 100a may come into contact with the second contact end portion 146 of the first contact bracket 140a disposed on the second electrostatic filter 100b.

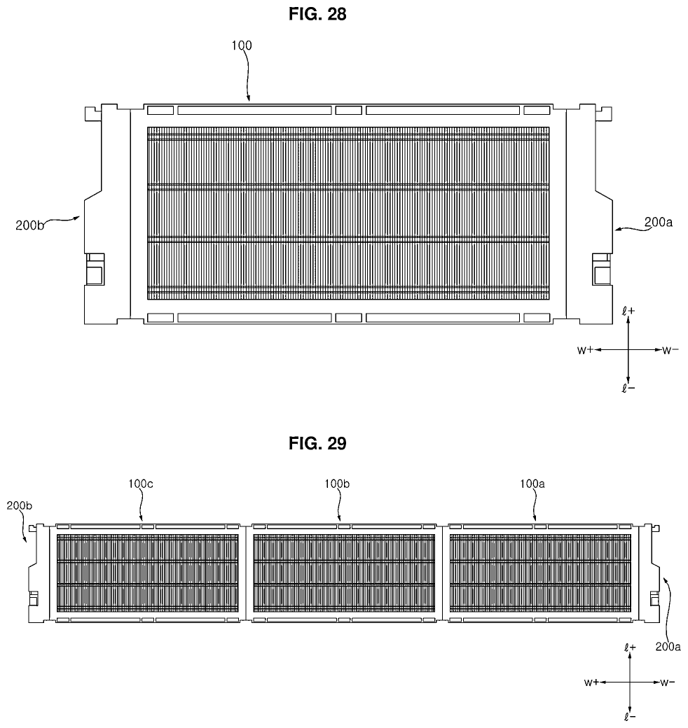

The number of electrostatic filters 100 disposed between the first filter handle 200a and the second filter handle 200b may vary according to the size of the air conditioner. That is, referring to FIG. 28, one electrostatic filter 100 may be disposed between the first filter handle 200a and the second filter handle 200b. Alternatively, referring to FIG. 29, three electrostatic filters 100a, 100b, and 100c may be disposed between the first filter handle 200a and the second filter handle 200b.

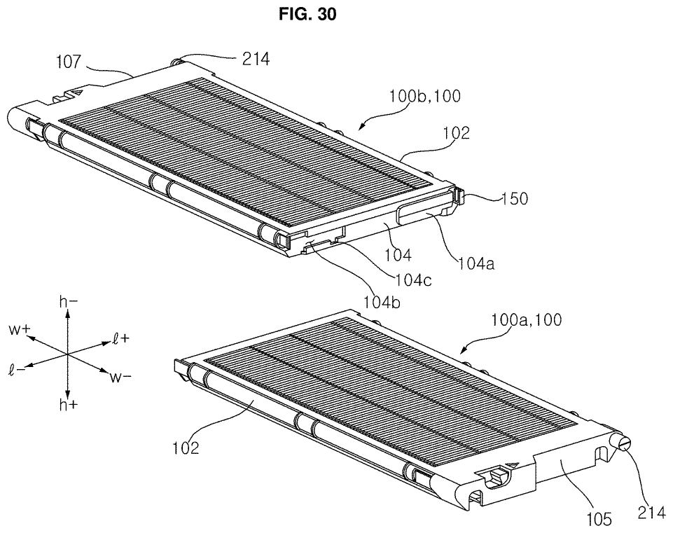

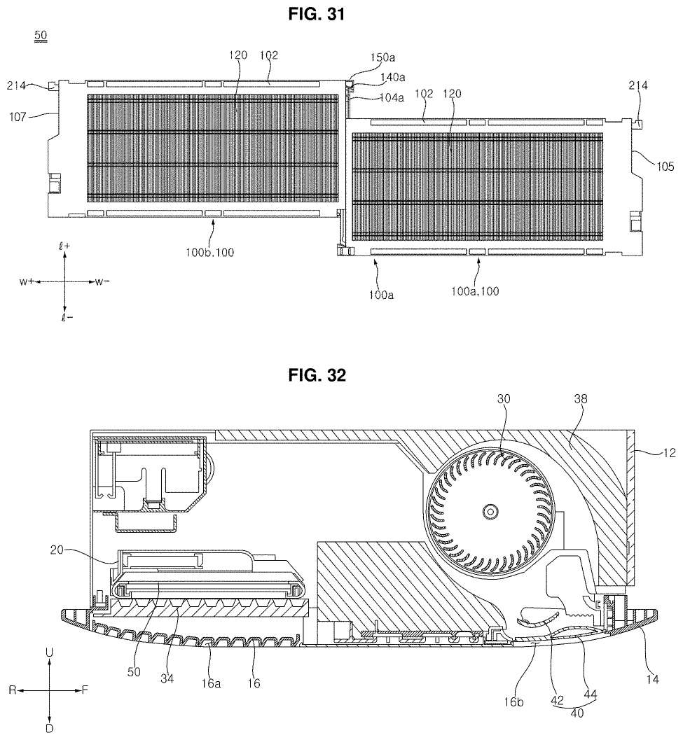

Referring to FIGS. 30 and 31, the filter handle may be mounted to the electrostatic filter to be configured as one. The electrostatic dust collector 50 includes a first electrostatic filter 100a and a second electrostatic filter 100b.

The first electrostatic filter 100a may be connected to the housing 10 at a first side wall 105. A fixing protrusion 214 engaged with the housing 10 may be disposed on the first side wall 105 of the first electrostatic filter 100a.

In addition, the first electrostatic filter 100a may be connected to the second electrostatic filter 100b at a second side wall 106. A second fastening protrusion (not shown) and a second fastening recess (not shown) are formed on the second side wall 106 of the first electrostatic filter 100a. The second fastening protrusion (not shown) and the second fastening recess (not shown) of the second side wall 106 of the first electrostatic filter 100a of this embodiment may have the same structure as the structure shown in FIG. 15.

The second electrostatic filter 100b may be connected to the housing 10 at a second side wall 107. A fixing protrusion 214 engaged with the housing 10 may be disposed on the second side wall 107 of the second electrostatic filter 100b.

In addition, the second electrostatic filter 100b may be connected to the first electrostatic filter 100a at a first side wall 104. A first fastening protrusion 104a and a first fastening recess 104b are formed on the first side wall 104 of the second electrostatic filter 100b. The first fastening protrusion 104a may have a shape corresponding to a second fastening recess. The first fastening recess 104b may have a shape corresponding to a second fastening protrusion.

Referring to FIG. 32, the air conditioner according to another embodiment of the present disclosure may have a structure without a heat exchanger. That is, the air conditioner may be provided therein with a pre-filter 34, an electrostatic dust collector 50, and a fan 30 by which air flows. The electrostatic dust collector 50 may include the structure described above and be mounted inside a housing 10.

In addition, a vane 40 for guiding the flow of discharged air may be provided. Although preferred embodiments of the present disclosure have been shown and described herein, the present disclosure is not limited to the specific embodiments described above. It will be understood that various modifications and changes can be made by those skilled in the art without departing from the idea and scope of the present disclosure as defined by the appended claims.

It is an aspect of the present disclosure to provide an air conditioner including an electrostatic dust collector that can be changed or adjusted in size according to the size of an inlet. It is another aspect of the present disclosure to provide an air conditioner with a simpler structure to allow an electrostatic filter and a filter handle to be easily coupled to or separated from each other. It is yet another aspect of the present disclosure to provide an air conditioner that can allow an electrostatic filter and a filter handle to be electrically connected to each other when the electrostatic filter or the filter handle is mounted. It is yet another aspect of the present disclosure to provide an air conditioner that can prevent safety accidents when an electrostatic dust collector is attached to or is detached from a housing. The aspects of the present disclosure are not limited to the aspects described above, and other aspects not stated herein will be clearly understood by those skilled in the art from the foregoing description.

According to one aspect of the subject matter described in this application, an air conditioner of the present disclosure includes: a housing having an inlet on one side thereof and an outlet on another side thereof; a fan disposed in the housing and by which air flows from the inlet to the outlet; and an electrostatic dust collector disposed in the housing and configured to remove foreign matter from air introduced into the inlet, allowing the air introduced into the inlet to be filtered. The electrostatic dust collector includes: at least one electrostatic filter including a first side wall and a second side wall disposed in an opposite direction to the first side wall; a first filter handle coupled to the first side wall; and a second filter handle coupled to the second side wall, allowing one or a plurality of electrostatic filters to be disposed between the first filter handle and the second filter handle.

The first side wall may be provided with a first coupling protrusion protruding outward and a first coupling recess recessed inward, and the second side wall may be provided with a second coupling protrusion protruding outward and a second coupling recess recessed inward, allowing the plurality of electrostatic filters to be coupled to each other.

The first coupling protrusion and the first coupling recess may be spaced apart from each other in a front-and-rear direction on the first side wall, and the second coupling protrusion and the second coupling recess may be spaced apart from each other in the front-and-rear direction on the second side wall, allowing the plurality of electrostatic filters to be coupled to each other. The first coupling protrusion and the second coupling protrusion may be disposed in opposite directions with respect to the front-and-rear direction, allowing the plurality of electrostatic filters to be coupled to each other.

The first side wall may have a structure corresponding to the second side wall, the first coupling protrusion may have a structure corresponding to the second coupling recess, and the first coupling recess may have a structure corresponding to the second coupling protrusion, allowing the plurality of electrostatic filters to be coupled to each other. The first filter handle may be provided with a first corresponding protrusion protruding from a first corresponding wall facing the first side wall to be inserted into the first coupling recess, and a first corresponding recess recessed into the first filter handle to allow the first coupling protrusion to be inserted therein. Accordingly, the plurality of electrostatic filters may be coupled to each other.

The electrostatic filter may include a button to fix the electrostatic filter or the filter handle, and the button may include a first button protrusion protruding upward from an upper surface of the electrostatic filter, a restoring plate to restore a position of the first button protrusion, and a second button protrusion disposed to protrude from the first coupling protrusion or the second coupling protrusion and configured to move together with the first button protrusion. Accordingly, electrostatic filters connected to each other may be coupled to or separated from each other.

A first fixing recess corresponding to the second button protrusion may be formed on one side of the first coupling recess, and a second fixing recess corresponding to the first button protrusion may be formed on one side of the second coupling recess. The first fixing recess and the second fixing recess may each be formed in a direction inclined to a direction in which the first coupling recess or the second coupling recess extends, allowing electrostatic filters to be easily coupled to each other.

The electrostatic filter may include: a case defining an outer appearance and having an opening portion through which air flows; a plurality of first electrostatic films provided in the case, disposed to be spaced apart from one another, and to which a high voltage is applied; a plurality of second electrostatic films provided in the case, disposed between the plurality of first electrostatic films, and to which a lower voltage relative to the plurality of first electrostatic films is applied; a first contact bracket disposed to be in contact with the plurality of first electrostatic films; and a second contact bracket disposed to be in contact with the plurality of second electrostatic films. Each of the first contact bracket and the second contact bracket may have both ends exposed to an outside of the case. Accordingly, the electrostatic filter and the filter handle or another electrostatic filter may be electrically connected to each other when connected to each other.

The each of the first contact bracket and the second contact bracket may include: a contact body disposed to be in contact with the plurality of first electrostatic films or the plurality of second electrostatic films; a first contact end portion exposed to one side of the case to be disposed on one side of the first coupling protrusion or the second coupling protrusion; and a second contact end portion exposed to another side of the case to be disposed on one side of the first coupling recess or the second coupling recess.

A protruding length of the first contact end portion to the outside of the case may be different from a protruding length of the second contact end portion to the outside of the case. Accordingly, coupling between the electrostatic filter and the filter handle or another electrostatic filter may not be interfered by the first contact end portion or the second contact end portion.

The first contact end portion may be disposed to protrude further than a side wall defining the first coupling protrusion or the second coupling protrusion, and the second contact end portion may be disposed so as not to protrude further than a side wall defining the first coupling recess or the second coupling recess, allowing the first contact end portion and the second contact end portion to be connected to each other when electrostatic filters are coupled to each other.

The first filter handle and the second filter handle may each include: an inner cover having a corresponding wall that faces the electrostatic filter; an outer cover disposed on one side of the inner cover, disposed in an opposite direction to the corresponding wall, and having an outer wall mounted to the housing; a first connector disposed to protrude from the corresponding wall of the inner cover; and a second connector spaced apart from the first connector and disposed to protrude from the corresponding wall of the inner cover. When the first filter handle or the second filter handle is connected to the electrostatic filter, the first connector and the second connector may be connected to the first contact end portion of each of the first contact bracket and the second contact bracket or the second contact end portion of each of the first contact bracket and the second contact bracket. Accordingly, the first filter handle and the second filter handle may be slidingly coupled to the electrostatic filter.

The corresponding wall of each of the first filter handle and the second filter handle may be provided with a corresponding recess in which the coupling protrusion formed on the first side wall or the second side wall is inserted, and a corresponding protrusion inserted into the coupling recess. The corresponding protrusion and the corresponding recess provided on the first filter handle may be disposed in an opposite direction to the corresponding protrusion and the corresponding recess provided on the second filter handle.

The outer wall of each of the first filter handle and the second handle may be provided with a fixing protrusion to fix the first filter handle and the second filter handle to the housing. The first connector may be disposed to protrude further than a wall surface defining the corresponding protrusion, and the second connector may be disposed so as not to protrude further than a wall surface defining the corresponding recess. Accordingly, the filter handle and the electrostatic filter may be electrically connected to each other when slidingly coupled to each other.

The first connector may include a first connecting plate disposed to protrude from the inner cover so as to be in contact with the contact bracket of the electrostatic filter, and a first exposure plate disposed at a first connector hole formed on the outer cover. The second connector may include a second connecting plate in contact with one side of the contact bracket of the electrostatic filter, and a second exposure plate disposed at a second connector hole formed on the outer cover. The first connecting plate may be disposed to protrude further than a wall surface defining the corresponding protrusion, and the second connecting plate may be disposed so as not to protrude further than a wall surface defining the corresponding recess. Accordingly, coupling between the filter handle and the electrostatic filter may not be interfered by the connectors.

The first connector may include a first contact plate extending from the first exposure plate in a direction in which the second connector is disposed, and the second connector may include a second contact plate extending from the second exposure plate in a direction in which the first connector is disposed. The first filter handle and the second filter handle may each include a switch that is disposed between the first connector and the second connector and causes the first contact plate and the second plate to be short-circuited or un-short-circuited. Accordingly, the first connector and the second connected may be short-circuited when the electrostatic dust collector is separated from the housing.

Details of other embodiments are included in the foregoing detailed description and the accompanying drawings. An air conditioner according to the present disclosure has one or more of the following aspects. First, as electrostatic filters disposed between two filter handles are configured to correspond to each other, an electrostatic dust collector may be changed or adjusted in size according to the size of an air conditioner. Second, as an electrostatic filter and a filter handle are slidingly coupled to each other and are configured to correspond to each other, the assembly and manufacture of the electrostatic filter and the filter handle may be facilitated. Third, in a sliding coupling structure, as a contact end portion in electrical contact to a coupling end portion is provided, an electrical connection between a plurality of electrostatic filters may be achieved when connected to each other. Fourth, as a switch is provided in a filter handle, contact between connectors may be short-circuited or released, thereby preventing safety accidents upon separation of an electrostatic dust collector. The aspects of the present disclosure are not limited to the effects described above, and other aspects not mentioned will be clearly understood by those skilled in the art from the claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An air conditioner comprising:
a housing;
a fan provided in the housing and configured to generate an air flow; and
an electrostatic dust collector provided in the space of the housing and configured to filter air,
wherein the electrostatic dust collector comprises:
an electrostatic filter including a first side wall and a second side wall provided opposite to the first side wall;
a first filter handle coupled to the first side wall; and
a second filter handle coupled to the second side wall.

2. The air conditioner of claim 1, wherein the first side wall includes a first coupling protrusion and a first coupling recess, and
wherein the second side wall includes a second coupling protrusion and a second coupling recess.

3. The air conditioner of claim 2, wherein the first coupling protrusion and the first coupling recess are spaced apart from each other in a front-and-rear direction on the first side wall, and
wherein the second coupling protrusion and the second coupling recess are spaced apart from each other in the front-and-rear direction on the second side wall.

4. The air conditioner of claim 3, wherein the first coupling protrusion and the second coupling protrusion are provided in respective opposite positions on the first and second side walls with respect to the front-and-rear direction.

5. The air conditioner of claim 2, wherein a structure of the first side wall corresponds to a structure of the second side wall,
wherein the first coupling protrusion is configured to be received in the second coupling recess, and
wherein the first coupling recess is configured to receive the second coupling protrusion.

6. The air conditioner of claim 2, wherein the first filter handle includes:
a first protrusion provided at a first wall facing the first side wall of electrostatic filter, the first protrusion being configured to be inserted into the first coupling recess; and
a first recess provided at the first wall of the first filter handle and configured to receive the first coupling protrusion.

7. The air conditioner of claim 2, wherein the electrostatic filter comprises a button to fix the electrostatic filter or the filter handle, and
wherein the button comprises:
a first button protrusion protruding upward from an upper surface of the electrostatic filter;
a restoring plate to restore a position of the first button protrusion; and
a second button protrusion protruding from at least one of the first coupling protrusion or the second coupling protrusion and configured to move together with the first button protrusion.

8. The air conditioner of claim 7, wherein the electrostatic filter includes:
a first fixing recess corresponding to the second button protrusion and formed on a side of the first coupling recess; and
a second fixing recess corresponding to the first button protrusion and formed on a side of the second coupling recess.

9. The air conditioner of claim 8, wherein the first fixing recess and the second fixing recess are inclined, respectively, to an extension direction of the first coupling recess or the second coupling recess.

10. The air conditioner of claim 1, wherein the electrostatic filter comprises:
a case defining an outer appearance and having an opening through which air flows;
a plurality of first electrostatic films provided in the case, provided to be spaced apart from one another, and to which a first voltage is applied;
a plurality of second electrostatic films provided in the case, provided respectively between the plurality of first electrostatic films, and to which a second voltage is applied, the second voltage being relatively smaller than the first voltage applied to the plurality of first electrostatic films;
a first contact bracket provided to be in contact with the plurality of first electrostatic films; and
a second contact bracket provided to be in contact with the plurality of second electrostatic films, and
wherein each of the first contact bracket and the second contact bracket has ends exposed to an outside of the case.

11. The air conditioner of claim 10, wherein the each of the first contact bracket and the second contact bracket comprises:
a contact body in contact with a corresponding one of the plurality of first electrostatic films or the plurality of second electrostatic films,
a first contact end portion exposed to one side of the case to be provided on a side of the first coupling recess or the second coupling recess; and
a second contact end portion exposed to another side of the case to be provided on a side of the first coupling protrusion or the second coupling protrusion.

12. The air conditioner of claim 11, wherein a protruding length of the first contact end portion to the outside of the case is different from a protruding length of the second contact end portion to the outside of the case.

13. The air conditioner of claim 11, wherein the second contact end portion protrudes further than a first section of the first side wall defining the first coupling protrusion or a first section of the second side wall defining the second coupling protrusion, and
wherein the first contact end portion does not protrude further than a second section of the first side wall defining the first coupling recess or a second section of the second side wall defining the second coupling recess.

14. The air conditioner of claim 11, wherein the first filter handle and the second filter handle each comprises:
an inner cover having a corresponding wall that faces the electrostatic filter;
an outer cover provided on one side of the inner cover, provided in an opposite direction to the corresponding wall of the inner cover, and having an outer wall mounted to the housing;
a first connector protruding from the corresponding wall of the inner cover; and
a second connector spaced apart from the first connector and protruding from the corresponding wall of the inner cover, and
wherein when at least one of the first filter handle or the second filter handle is connected to the electrostatic filter, the first connector is connected to the first contact end portion of the first contact bracket or the second contact bracket and the second connector is connected to the second contact end portion of the first contact bracket of the second contact bracket.

15. The air conditioner of claim 14, wherein the corresponding wall of each of the first filter handle and the second filter handle includes:
a corresponding recess in which the first coupling protrusion formed on the first side wall or the second coupling protrusion formed on the second side wall is inserted, and
a corresponding protrusion inserted into the first coupling recess or the second coupling recess.

16. The air conditioner of claim 15, wherein the corresponding protrusion and the corresponding recess formed on the first filter handle are provided in an opposite orientation with respect to the corresponding protrusion and the corresponding recess formed on the second filter handle.

17. The air conditioner of claim 14, wherein the outer wall of each of the first filter handle and the second handle includes a fixing protrusion to fix the first filter handle and the second filter handle to the housing.

18. The air conditioner of claim 14, wherein the first connector protrudes further than a wall surface defining the corresponding protrusion, and the second connector does no protrude further than a wall surface defining the corresponding recess.

19. The air conditioner of claim 14, wherein the first connector comprises a first connecting plate protruding from the inner cover so as to be in contact with the contact bracket of the electrostatic filter, and a first exposure plate provided at a first connector hole formed on the outer cover,
wherein the second connector comprises a second connecting plate in contact with one side of the contact bracket of the electrostatic filter, and a second exposure plate provided at a second connector hole formed on the outer cover, and
wherein the first connecting plate protrudes further than a wall surface defining the corresponding protrusion, and the second connecting plate does not protrude further than a wall surface defining the corresponding recess.

20. The air conditioner of claim 19, wherein the first connector comprises a first contact plate extending from the first exposure plate in a direction in which the second connector is positioned,
wherein the second connector comprises a second contact plate extending from the second exposure plate in a direction in which the first connector is positioned, and
wherein the first filter handle and the second filter handle each comprises a switch that is provided between the first connector and the second connector and causes the first contact plate and the second plate to be selectively electrically coupled.
